(19) United States
(12) Patent Application Publication
(10) Pub. No.: US 2005/0281980 A1
(43) Pub. Date: Dec. 22, 2005

(54) Vacuum pressure bag for use with large scale composite structures

(76) Inventors: Jose A. Cruz, Sturgis, MI (US); John A. Wegener, Granger, IN (US); James G. Bledsoe, Goshen, IN (US); Donald C. Ray, Angola, IN (US); Gordon J. Frost, LaGrange, IN (US); Steven L. Kilmer, Elkhart, IN (US); John M. Reed, Cassopolis, MI (US)

Correspondence Address: OWENS CORNING, 2790 COLUMBUS ROAD, GRANVILLE, OH, 43023, US

(21) Appl. No.: 10/874,119

(22) Filed: Jun. 22, 2004

(51) Int. Cl. B27N 3/10; B29C 70/30

(52) U.S. Cl. 428/131; 264/510; 264/316; 264/338; 264/257; 156/285; 428/98; 442/286; 442/394

(57) ABSTRACT

A method and apparatus for manufacturing an improved composite article which reduces the time and expense of manufacturing a composite article and which provides an improved back surface to the composite article. The apparatus includes an improved vacuum seal that provides for improved surface characteristics and improved manufacturability.

### TECHNICAL FIELD AND INDUSTRIAL APPLICABILITY OF THE INVENTION

This invention relates to a method and apparatus for the use of a vacuum pressure bag for use in the manufacture of fiber-reinforced panels, to a method and apparatus for the manufacture of composite structures.

### BACKGROUND OF THE INVENTION

Recreational vehicles, especially Class A motor homes, may use composite sheets, such as glass fiber-reinforced wall panels, for the exterior surface of a recreational vehicle. These wall panels vary in widths up to 6 to 11 ft. (2 to 3.6 m) and can have any length typically 18-48 ft. (6-16 m) or more. While the composite material from which the panels are made provides an adequate material for the recreational vehicle side walls, it would be advantageous to provide an improved composite sheet having fewer defects, increased interlayer bond strength and decreased process variability.

Typically, a mold, such as a fiberglass reinforced mold, having a size larger than a composite article such as a 10×40 ft (3×12 meter) composite sheet, has the materials deposited therein by several passes of various applicators to build up a layered preform. Generally, the composite article is layered so that the decorative layer is applied directly to the mold and the structural layers including a fiberglass reinforced resin layer and a board layer are subsequently applied. When the composite article is cured, it is removed from the mold, cut to size, the back side is ground to roughen the material which bleeds through the luaun and shipped to the consumer where it is installed, for example as a recreational vehicle side wall.

### SUMMARY OF THE INVENTION

The present invention provides a method and apparatus for manufacturing an improved composite article which reduces the time and expense of manufacturing a composite article and which provides an improved back surface to the composite article. It is an object of the present invention to provide an apparatus, a method of manufacture and a composite article.

### BRIEF DESCRIPTION OF THE DRAWING

FIG. 1 is a cross-sectional view of the manufacture of a composite article according to one embodiment of the present invention.

FIG. 2 is a view of the manufacture of a composite article according to one embodiment of the present invention showing a vacuum formed over the composite article.

FIG. 3 is a detail of FIG. 2 showing a frame, perimeter seal, and flexible seal useful in the present invention lowered onto the composite article.

FIG. 4 is an expanded cross-sectional view of a flexible seal according to one embodiment of the invention.

FIG. 5 is a plan view of the underside of a flexible seal according to one embodiment of the present invention.

FIG. 6 is a plan view of the underside of a flexible seal according to another embodiment of the present invention.

FIG. 6A is an expanded cross-sectional view taken along line 6A-6A in FIG. 6.

FIG. 7 is an isometric view of the exposed surface of the reinforcement panel of a composite article manufactured according to one embodiment of the present invention.

### DETAILED DESCRIPTION AND PREFERED EMBODIMENTS OF THE INVENTION

One method of manufacturing large scale composite articles, such as recreational vehicle sidewalls is shown in commonly assigned Published U.S. Patent Application No. 2003-0143373, filed Jan. 31, 2002 and published Jul. 31, 2003 (herein incorporated in its entirety by reference).

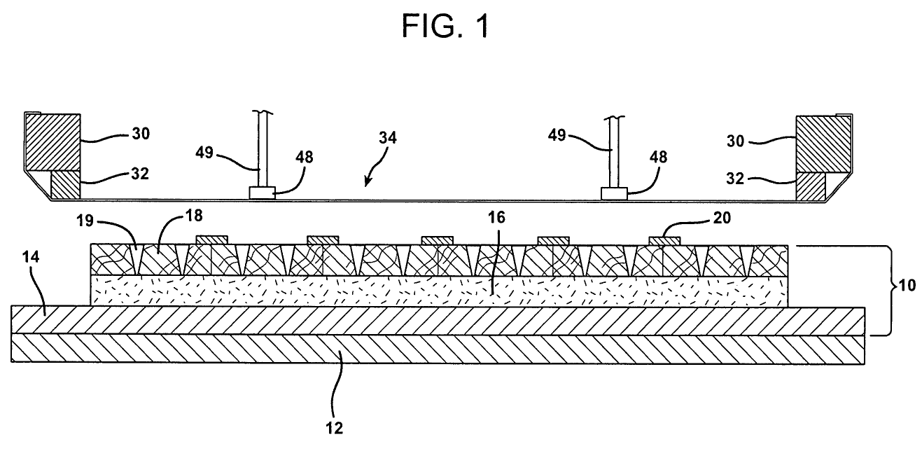

The composite article of the present invention is manufactured in a multi-layer structure 10 on a mold 12, as shown in FIG. 1. The multilayer structure is typically built upon the surface of mold 12 by applying a gel-coat or decorative layer 14, a resinated glass reinforcement layer 16 and a reinforcement panel layer 18. When installed, for example on a recreational vehicle, the gel-coat layer 14 forms the exterior of the vehicle and the reinforcement panel layer 18 is mounted to the body of the vehicle.

Gel-coat 14 is typically a commercially available quick setting polymer which cures to form a high gloss exterior surface for the finished composite article. The gel-coat 14 may include a pigment and provides a durable finish. The gel-coat 14 may be applied in one or more layers by a sprayer moved latitudinally and longitudinally along the entire length of the mold 12. Such sprayers are commercially available from Magnum Venus of Kent, Wash. The sprayer traverses the mold 12 to spray gel-coat 14 in a substantially uniform thickness. The gel-coat 14 may be a polymer having a catalyst which sets up to a gel in about 20 minutes and cures in about 35 minutes. Commercially available materials which are suitable for use as a gel-coat 14 in the present invention include any polymer based gel-coat known to one skilled in the art.

A composite mixture of resin and reinforcement material, such as chopped fiberglass, is typically applied to the gel-coat to form reinforcement layer 16. The resin typically includes a polyester resin or a polyester/epoxy blend resins having low shrink characteristics. The resin is typically applied by a resin sprayer and reinforcement fibers such as fiberglass are applied by a fiberglass chopper/applicator that are moved latitudinally and longitudinally to define the size of the composite article. Such laminating reciprocators are commercially available from Magnum Venus of Kent, Wash. The fiberglass chopper/applicator takes a fiberglass tow (such as a Type 359, ME 3015 or Type ME 3021 available from Owens Corning of Toledo, Ohio) from a spool, chops the tow to form discrete fibers having a length of up to about 3 inches (8 cm) and preferably 1-1.25 inches (2.5-3 cm) and dispenses the chopped fibers on the gel-coat to form a reinforcement layer 16 when the resin is applied. One or more resin sprayers and fiberglass chopper/applicators may be used to apply the resin and fiberglass. Depending upon process parameters and the desired structure of the finished composite article, the resin and fiberglass may be deposited in any order or simultaneously, or may be deposited in a layered fashion. Another alternative is to use a combined resin sprayer and fiber chopper/applicator so that resinated fibers are deposited. The glass and resin layers may then be compressed with weighted rollers to wet out the fibers and to remove voids. Any known commercially available polyester resin suitable for use in the particular application may be used.

It is also possible to replace the chopped fiberglass fibers with glass mat or other suitable reinforcement material. The mat is saturated with the resin and applied to the gel-coat 14. The use of a glass mat in the reinforcement layer 16 eliminating the steps of applying the chopped fiberglass. The use of a mat provides a nearly constant fiber density across the surface of the composite article and can provide additional strength through the use of a stitched or knitted mat.

The reinforcement layer is then rolled to remove air, break up glass bundles remaining from the fiberglass tow and to resinate the fibers. Finally, reinforcement panels 18 are applied. The reinforcement panels 18 are typically, low cost, luaun plywood having a rotary cut veneer with a sapwood streak, typically referred to as luaun. Medium density fiberboard (MDF) may also be used as a reinforcement panel 18. Each reinforcement panel 18 typically has a thickness of about ⅛^{th} in. (3.4 mm) and a relatively smooth surface and a relatively rough second surface. The smooth surface is applied and the panels 18 are abutted. Strips of webbing 20, such as strips of fiberglass mat wetted with a catalyzed resin, may be applied at each seam after the application of the reinforcement panel 18. Depending on the final use of the composite article, the panels may include substantially thicker panels depending on the application.

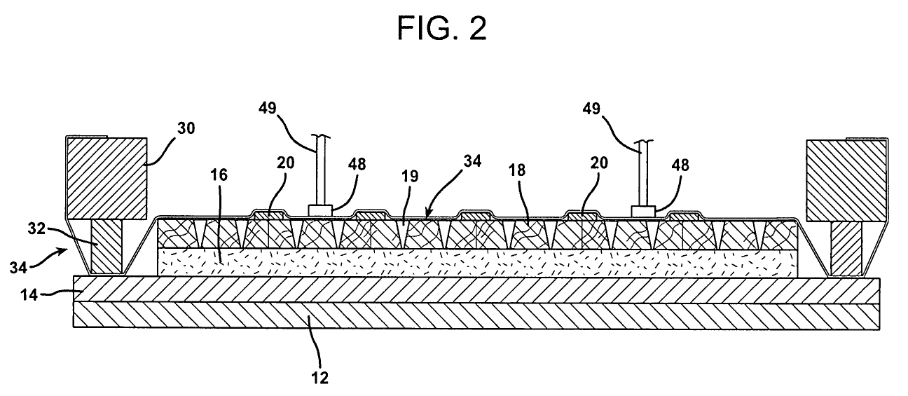

As shown in FIG. 2, the composite article 10 is built up on mold 12 and the uncured composite article 10 is covered with a flexible seal 34 attached to frame 30 and perimeter seal 32. The flexible seal 34 is placed over the composite article 10 and the frame 30 and perimeter seal 32 contact the mold 12 to form an air tight evacuation area over the composite article 10. The flexible seal 34 includes a plurality of vacuum lines 49 connected to a vacuum pump (not shown). The vacuum pump draws a vacuum within the evacuation area and the layers of the composite sheet 10 together and removes gasses entrapped below the reinforcement panels 18. The evacuation area is drawn to a pressure of 5-10 inches (125-250 mm) of mercury below the atmospheric pressure and maintained for a period to allow the resin to cure past the gel point of the resin (10 or more minutes) and preferably until the resin is substantially cured (typically 20 or more minutes). During the vacuum process, material resin of the reinforcement layer 16 is drawn into the perforations 19 of reinforcement panels 18.

After the reinforcement layer 16 cures for a suitable time (typically 10-30 minutes) flexible seal 34, frame 30 and perimeter seal 32 are removed from mold 12. After a suitable additional cure time, typically 90 or more minutes after the flexible seal 34 is removed, the composite article 10 is removed from the mold. The composite article 10 is then cut to size and shape required.

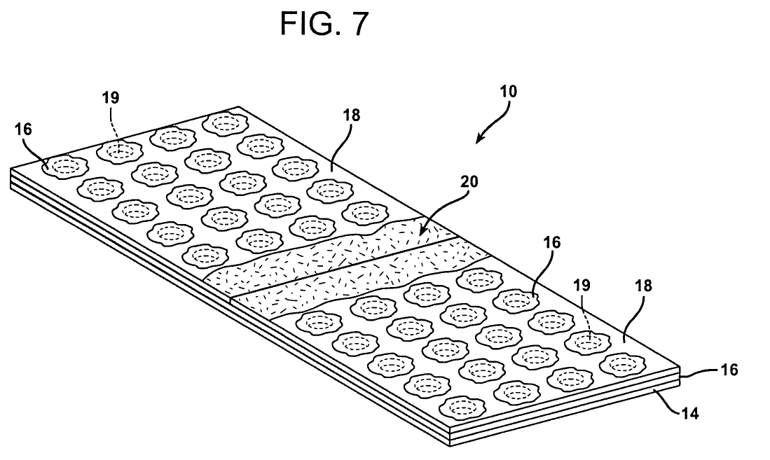

As shown in FIG. 7, the resulting composite article 10 has a substantially exposed surface of the reinforcement panel 18 with resin 16 on the surface at the perforations 19 and at the resinated webbing 20. The exposed resin 16 is substantially uniform thickness and greatly reduces the need for grinding or sanding of the exposed surface of the reinforcement panels 18. Typically, the resin 16 at the perforations 19 is less than 0.010 in (0.254 mm) and it is unnecessary to grind resin 16 at the perforations. Additionally, perforations 19 are not present in all boards, and the resin is flows at the seams and/or edges. Overall, the grinding time typically performed on the composite article 10 of the present invention is reduced up to two thirds or more, verses composite articles of the prior art for a 40 ft (12 m) long surface, and preferably no grinding is required.

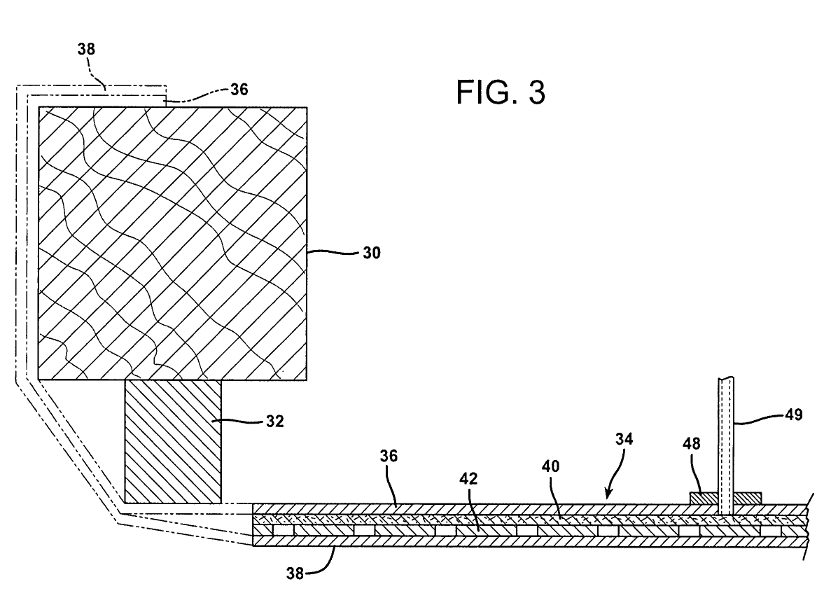

FIG. 3 shows a cross-sectional view of the frame 30, perimeter seal 32 and flexible seal 34. The frame 30 may be formed of any suitable structural material, for example wood, steel or aluminum, provided that the material will support the weight of perimeter seal 32 and flexible seal 34 while being placed on and removed from mold 12. The perimeter seal 32 may be of any suitable material, such as rubber, silicon based rubber, silicone or any foamed polymer, provided that the material will form a seal sufficient to hold the vacuum formed in the evacuation area under flexible seal 34.

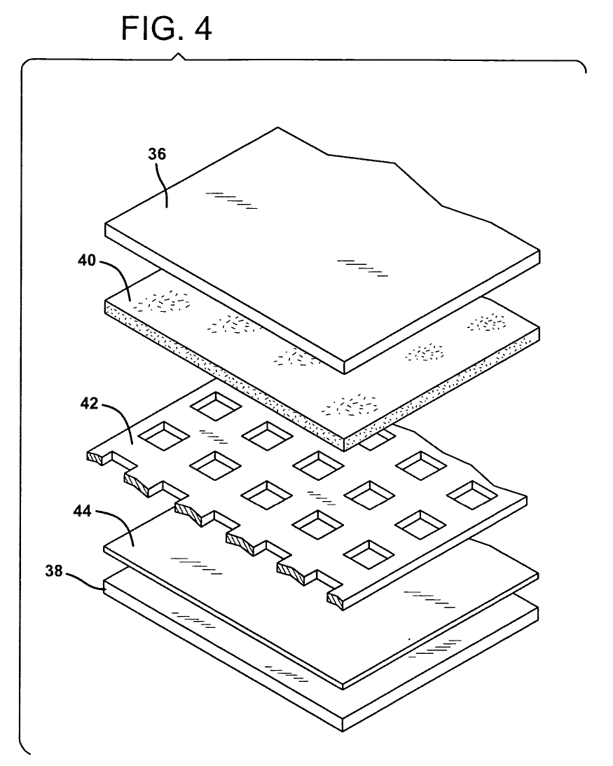

As shown in FIG. 4, flexible seal 34 is preferably a multilayer structure that includes upper seal layer 36, lower seal layer 38, having a contact surface on the underside, and an air flow layer 40, flow layer 42 and secondary seal layer 44. The flexible seal 34 also includes a number of vacuum ports 48 and vacuum lines 49 that evacuate air from the evacuation area. The upper seal layer 36 may be formed of any suitable flexible sheet which is substantially impermeable to gas flow at a pressure difference of 5-7 inches (125-175 mm) of mercury between the evacuation area and the atmosphere. Suitable materials for the upper seal layer 36 include vinyl, rubber, Ethylene Propylene Diene Monomer (EPDM), latex, and polyester.

The secondary seal layer 44 may be formed of any suitable flexible sheet which is substantially resistant to degradation by the resin used in the reinforcement layer 16 and able to withstand the forces produced at a pressure difference of 5-7 inches (125-175 mm) of mercury between the evacuation area and the atmosphere. The lower seal layer 38 may be formed of any suitable flexible sheet which is substantially resistant to degradation by the resin used in the reinforcement layer 16 and able to withstand the forces produced at a pressure difference of 5-7 inches (125-175 mm) of mercury between the evacuation area and the atmosphere. Suitable materials for the secondary seal layer 44 and lower seal layer 38 include vinyl, rubber, Ethylene Propylene Diene Monomer (EPDM), latex, polyester and polyester films such as MYLAR.

In a preferred embodiment the lower seal includes a textured lower surface that provides a textured surface on the resin 16 which is drawn through the reinforcement panel 18. One suitable texture is a level hair cell texture. Any suitable texture may include a substantially flat surface having an average crevice depth of at least about 5 μm and preferably 5-50 μm. The texture may be formed by abrading the surface of the sheet or by inclusion of particulate in the material from which the sheet is formed. For example EPDM sheeting which is sold as roofing rubber includes a particulate which has a size of between about 5-50 μm and, depending upon processing and wear may include crevices of up to 50 μm. The textured surface on the resin 16 provides an improved bond with the adhesive applied by a vehicle fabricator. Air flow layer 40 may be any suitable material which allows the passage of air and resists compression under pressure. Suitable materials are melt-blown polymer fibers such as commercially available air filtration media (available from EXFIL Co. of Kalamazoo, Mich., sold under the trade name FM-50). The flow layer 42 is typically substantially resistant to compression at a pressure differential of 5-7 inches (125-175 mm) of mercury and allows the flow of air and resin material into the flow layer 42 without a substantial amount of resin contacting the air flow layer 40. Suitable materials include woven and non-woven mats, grids and molded mats and a plastic mesh having a height, typically 1/16^{th} of an inch (1.5 mm), and open area, such as a ¼ inch (6 mm) low density polyethylene mesh (available from MRS of St. Joseph, Mich.). Another suitable material may include on or more of the following fused and entangled filaments for drainage media such as Enkadrain 5006, 7001, 7004, 7005 and 8004 (available from Colbond of Enka, N.C.) and any other suitable fibrous or felted material.

The contact surface of lower seal layer 38 is preferably coated with a release agent. The use of release agent allows for increased manufacturing cycles before scheduled down time for cleaning or replacement of the flexible seal.

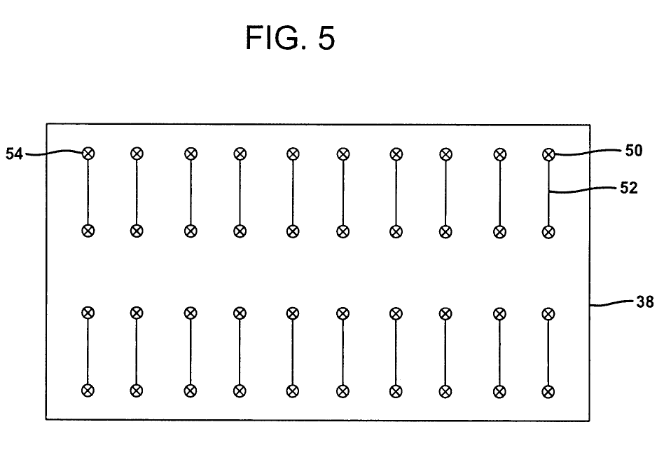

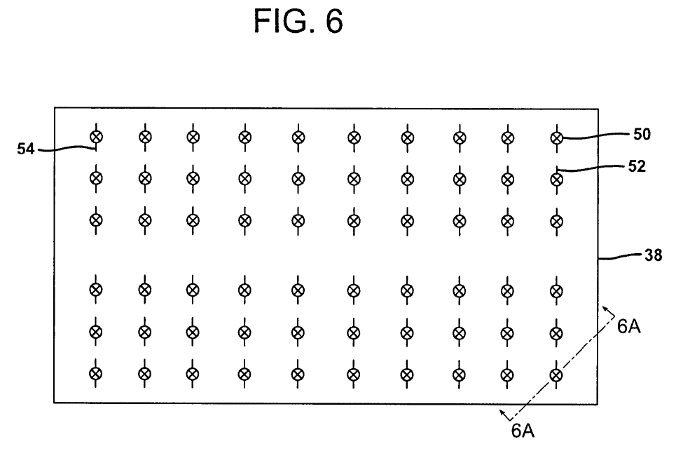

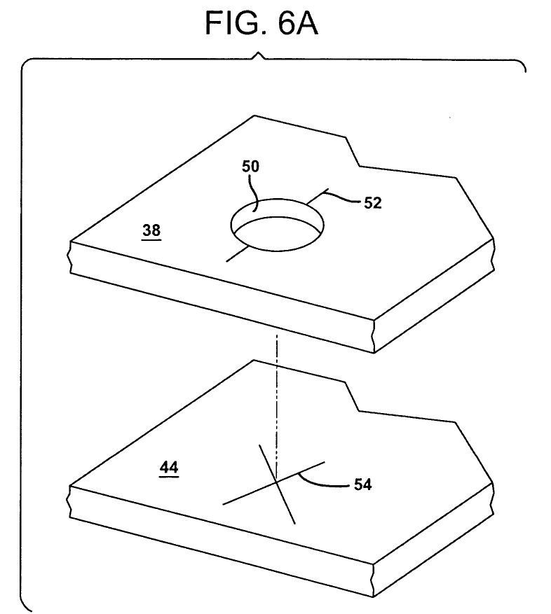

FIG. 5 and FIG. 6 show the contact surface of lower seal layer 38. The lower seal layer includes a plurality of holes 50 which expose incisions 54 made in secondary seal layer 44. The incisions may be of any shape which allows the flow of gasses out from the evacuation area under vacuum. Preferably the incisions 54 inhibit the flow of resin from the upper surface of reinforcement panels 20 into flow layer 42, for example X-shaped incisions have been found to fit these criteria. The holes 50 may be of any suitable diameter and may optionally include one or more slits 52 to improve air flow from the evacuation area. FIG. 5 shows the lower surface of a flexible seal 34 useful with the present invention. Typical composite articles 10 made according to the present invention may exceed 50 feet (15.2 m.). FIG. 5 shows a 44 ft (13.4 m.) flexible seal 34 having two rows of paired holes 50 spaced 5 ft. (1.5 m.) apart and connected by a slit 52. The ten pairs of holes in each row are separated from the adjacent pair by approximately 4.0 ft. (1.2 m.). The top and bottom rows are 2 ft (0.6 m.) apart. FIG. 6 is similar to FIG. 5 but includes a central hole 50 between hole pairs rather than the slit 52 shown in FIG. 5. Each hole 50 in FIG. 6 may optionally include a lateral slit to improve air flow. FIG. 6A is an expanded cross-sectional view, taken along line 6A of FIG. 6, of the lower seal layer 38 including hole 50 and slit 52 and secondary seal layer 44 including X-shaped incisions. Any suitable hole pattern which allows sufficient air flow from the evacuation area would be acceptable.

### EXAMPLE

On a mold, two layers of gel-coat were applied to a thickness of 0.016 inches (0.41 mm) and allowed to cure for 60 minutes. The reinforcing layer of 62 wt. % resin and 38 wt. % glass were applied to a depth of 0.080 in (2 mm) on the gel-coat and rolled to wet out the fibers and remove bubbles. Resin, and glass fibers chopped to a length of 1 1/16 inch (27 mm), were used. Perforated luaun panels of 4×10 ft (1.2×3 m) were applied and fiberglass webbing resinated with the resin was applied at the seams of the luaun panels. The perforations in the luaun panels were evenly spaced 4×4 in. (100×100 mm) grid pattern and were roughly a truncated conical shape having a diameter of 1/16 inch (1.6 mm) on the lower surface and 3/16 inch (4.8 mm) on the upper surface of the board. A 6 in (150 mm) wide strip of MYLAR polyester film was placed at the edges of the gel-coat where the perimeter seal makes contact. The 48 foot (14.6 m) flexible seal was coated with 2 gallons (8.8 l) of FREKOTE EFR release agent, available from Loctite corporation of Rocky Hill, Conn., was applied and the pressure under the seal was drawn to 7 inches (175 mm) of mercury below the atmospheric pressure. The resin was allowed to cure for 24 minutes and the vacuum was released and the flexible seal was removed. The resin was allowed to cure an additional 90 minutes and the panel was removed from the mold. The resulting panel had a substantially uniform resin layer on the upper surface of the luaun which exhibited an even mat finish. The panel required only minimal machining on the upper surface thereof as compared to that required for panels of the prior art.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A flexible seal for use in forming a composite article, comprising:
a perforated lower barrier layer having a textured surface on one side thereof.

2. The flexible seal of claim 1, further comprising:
an intermediate layer; and
an imperforate upper barrier layer.

3. The flexible seal of claim 2, wherein said intermediate layer comprises at least one layer selected from the group consisting of: an air flow layer, a flow layer, and an intermediate perforated barrier layer.

4. The flexible seal of claim 3, wherein the intermediate perforated barrier layer is formed of a material selected from the group consisting essentially of vinyl, rubber, Ethylene Propylene Diene Monomer (EPDM), latex, and polyester.

5. The flexible seal of claim 3, wherein the intermediate barrier layer is a polyester film.

6. The flexible seal of claim 3, wherein the flow layer allows the passage of gas and liquid but is of a sufficient height to prevent a substantial amount of liquid from contacting said air flow layer.

7) The flexible seal of claim 3, wherein the flow layer allows the passage of gas and liquid but is of a sufficient height to prevent a substantial amount of liquid from contacting said imperforate upper barrier layer.

8. The flexible seal of claim 3, wherein the flow layer is formed of a polymer and has a structure selected from the group consisting essential of woven and non-woven mats, mesh, grids and molded mats.

9. The flexible seal of claim 2, further comprising vacuum ports in the imperforate upper barrier layer.

10. The flexible seal of claim 1, further comprising a frame.

11. The flexible seal of claim 1, wherein the lower barrier layer is formed of a material selected from the group consisting essentially of vinyl, rubber, Ethylene Propylene Diene Monomer latex, and polyester.

12. The flexible seal of claim 1, wherein the textured surface is a level hair cell texture.

13. The flexible seal of claim 1, wherein the textured surface includes surface discontinuities of at least 5 μm.

14. The flexible seal of claim 13, wherein the textured surface includes surface discontinuities of between about 5 μm and 50 μm.

15. A method of manufacturing a composite article, comprising the steps of:
providing a mold surface onto which a composite article may be formed;
applying at least one outer coat of material onto the mold surface;
forming a reinforcement layer by applying at least one coat of resin and reinforcement material over the outer coat;
applying a reinforcement panel to the reinforcement layer;
applying a flexible seal including a perforated lower barrier layer, an intermediate layer and an imperforate upper barrier layer;
drawing a vacuum under the flexible seal to bond the reinforcement layer to the reinforcement panel.

16. The method of manufacturing a composite article of claim 15, wherein said intermediate layer comprises at one or more layer selected from the group consisting of: an air flow layer, a flow layer, and an intermediate perforated barrier layer.

17. The method of manufacturing a composite article of claim 15, wherein said reinforcement panel includes perforations.

18. The method of manufacturing a composite article of claim 17, wherein said drawing step includes the step of drawing resin into said perforations.

19. The method of manufacturing a composite article of claim 18, wherein said applying a flexible seal step includes the step of positioning a frame having a perimeter seal and the flexible seal attached thereto over the mold and forming a vacuum between said flexible seal and said mold.

20. The method of manufacturing a composite article of claim 18, wherein said drawing a vacuum step includes drawing a pressure of 5-10 inches of mercury below the atmospheric pressure.

21. The method of manufacturing a composite article of claim 20, wherein said drawing a vacuum step includes drawing a pressure of 6-8 inches of mercury below the atmospheric pressure.

22. The method of manufacturing a composite article of claim 20, wherein said drawing a vacuum step includes maintaining said vacuum for a period to allow the resin to cure past the gel point of the resin.

23. The method of manufacturing a composite article of claim 20, wherein said drawing a vacuum step includes maintaining said vacuum for more than 10 minutes.

24. The method of manufacturing a composite article of claim 20, wherein said drawing a vacuum step includes maintaining said vacuum for more than 20 minutes.

25. The method of manufacturing a composite article of claim 20, wherein said drawing a vacuum step includes maintaining said vacuum for approximately 24 minutes.

26. The method of manufacturing a composite article of claim 18, wherein said drawing a vacuum step includes maintaining said vacuum for a period to allow the resin to cure past the gel point of the resin.

27. The method of manufacturing a composite article of claim 18, wherein said drawing a vacuum step includes maintaining said vacuum for more than 10 minutes.

28. The method of manufacturing a composite article of claim 18, wherein said drawing a vacuum step includes maintaining said vacuum for more than 20 minutes.

29. The method of manufacturing a composite article of claim 18, wherein said drawing a vacuum step includes maintaining said vacuum for approximately 24 minutes.

30. The method of manufacturing a composite article of claim 18, further comprising the step of applying a release agent to said flexible seal prior to said applying a flexible seal step.

31. The method of manufacturing a composite article of claim 15, wherein the lower barrier layer includes a textured surface that is a level hair cell texture.

32. The method of manufacturing a composite article of claim 15, wherein the lower barrier layer includes a textured surface, wherein the textured surface includes surface discontinuities of at least 5 μm.

33. The method of manufacturing a composite article of claim 15, wherein the lower barrier layer includes a textured surface, wherein the textured surface includes surface discontinuities of between about 5 μm and 50 μm.

34. A composite article having exposed resin having a textured surface on one side manufactured by the method of:
providing a mold surface onto which a composite article may be formed;
applying at least one outer coat of material onto the mold surface;
forming a reinforcement layer by applying at least one coat of resin and reinforcement material over the outer coat;
applying a reinforcement panel to the reinforcement layer;
applying a flexible seal including a perforated lower barrier layer having a textured lower surface, and an imperforate upper barrier layer;
drawing a vacuum under the flexible seal to draw the resin into the reinforcement panel, thereby bonding the reinforcement layer to the reinforcement panel.

35) The method of manufacturing a composite article of claim 34, wherein the lower barrier layer includes a textured surface, wherein the textured surface includes surface discontinuities of at least 5 μm.

36. The composite article of claim 34, wherein said panel comprises a plurality of perforations in the reinforcement panel, and wherein the resin is draw into the perforations, thereby bonding the reinforcement layer to the reinforcement panel.

37. The composite article of claim 36, wherein said intermediate layer comprises at least one layer selected from the group consisting of: an air flow layer, a flow layer, and an intermediate perforated barrier layer.

38. The composite article of claim 36, wherein the method further comprises the step of applying a release agent to said flexible seal prior to said applying a flexible seal step.

39. The method of manufacturing a composite article of claim 36, wherein said drawing a vacuum step includes drawing a pressure of 5-10 inches of mercury below the atmospheric pressure.

40. The method of manufacturing a composite article of claim 39, wherein said drawing a vacuum step includes drawing a pressure of 7-9 inches of mercury below the atmospheric pressure.

41. The method of manufacturing a composite article of claim 39, wherein said drawing a vacuum step includes maintaining said vacuum for a period to allow the resin to cure past the gel point of the resin.

42. The method of manufacturing a composite article of claim 39, wherein said drawing a vacuum step includes maintaining said vacuum for more than 10 minutes.

43. The method of manufacturing a composite article of claim 36, wherein the lower barrier layer includes a textured surface that is a level hair cell texture.

44. The method of manufacturing a composite article of claim 36, wherein the lower barrier layer includes a textured surface, wherein the textured surface includes surface discontinuities of at least 5 μm.

45. The method of manufacturing a composite article of claim 36, wherein the lower barrier layer includes a textured surface, wherein the textured surface includes surface discontinuities of between about 5 μm and 50 μm.

46. A flexible seal for use in forming a composite article comprising:
a perforated lower barrier layer;
an intermediate layer; and
an imperforate upper barrier layer.

47. The flexible seal of claim 46, wherein the intermediate layer comprises at least one layer selected from the group consisting of: an air flow layer, a flow layer, and an intermediate perforated barrier layer.

48. The flexible seal of claim 47, wherein the flow layer allows the passage of gas and liquid but is of a sufficient height to prevent a substantial amount of liquid from contacting said air flow layer.

49. The flexible seal of claim 47, wherein the flow layer is formed of a polymer and has a structure selected from the group consisting essentially of woven and non-woven mats, mesh, grids and molded mats.

50. The flexible seal of claim 46, wherein the intermediate layer is formed of a material selected from the group consisting essentially of vinyl, rubber, Ethylene Propylene Diene Monomer (EPDM), latex, and polyester.

51. The flexible seal of claim 50, wherein the intermediate barrier layer is a polyester film.

52. The flexible seal of claim 46, wherein the lower barrier layer includes a textured lower surface.

53. The flexible seal of claim 46, wherein the lower barrier layer is formed of a material selected from the group consisting essentially of vinyl, rubber, Ethylene Propylene Diene Monomer latex, and polyester.

54. The flexible seal of claim 46, wherein the perforated lower barrier includes a textured surface.

55. The flexible seal of claim 54, wherein the textured surface includes surface discontinuities of at least 5 μm.

56. The flexible seal of claim 54, wherein the textured surface includes surface discontinuities of between about 5 μm and 50 μm.
